(19) United States
(12) Patent Application Publication
(10) Pub. No.: US 2013/0040793 A1
(43) Pub. Date: Feb. 14, 2013

(54) Segmented Roll Assembly and Stopping Device for a Segmented Roll

(71) Applicant: Pekka Eronen, Jarvenpaa (FI)

(72) Inventor: Pekka Eronen, Jarvenpaa (FI)

(73) Assignee: METSO PAPER, INC., Helsinki (FI)

(21) Appl. No.: 13/643,288

(22) PCT Filed: Apr. 21, 2011
(86) PCT No.: PCT/FI2011/050369

§ 371 Date: Oct. 24, 2012

(30) Foreign Application Priority Data
Apr. 27, 2010 (FI) U20100209

(51) Int. Cl. F16C 13/00; B65H 23/025; B65H 23/04; F16D 49/00; B65H 23/06

(52) U.S. Cl. 492/15; 188/74

(57) ABSTRACT

A stopping device (10) for a segmented roll in a fiber-web machine for assisting the stopping of the rotation of one or more roll segment(s) (52) of the segmented roll (50) has at least one braking device (12), by means of which the roll segment (52) can be stopped, and at least one surface contact member (14, 14′), which surface contact member is connected to said braking device, and the stopping device further comprises actuators (16) for optionally bringing/releasing the surface contact member into/from surface contact with the shell of one or more roll segment(s) (52). The invention also relates to a segmented roll assembly (60) in a fiber-web machine, in which the segmented roll (50) comprises at least two, independently from one another rotatable roll segments (52) that are located end-to-end substantially in the transverse direction of the fiber-web machine.

### CROSS REFERENCES TO RELATED APPLICATIONS

This application is a U.S. national stage application of International App. No. PCT/FI2011/050369, filed Apr. 21, 2011, the disclosure of which is incorporated by reference herein, and claims priority on Finnish App. No. U20100209, filed Apr. 27, 2010.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The invention relates to a stopping device for a segmented roll in a fiber-web machine for assisting the stopping of the rotation of one or more roll segment(s) of the segmented roll. The invention also relates to a segmented roll assembly for a fiber-web machine, in which the segmented roll comprises at least two, independently from one another rotatable roll segments that are located end-to-end substantially in the transverse direction of the fiber-web machine.

In fiber-web machines, it is known to use so-called segmented rolls, which, as indicated by their name, are composed of roll segments shorter than the entire roll length. If so required, the bow of the segmented roll can be adjusted by changing the position and/or distance of the support points of the individual roll segments in regard to the mounting frame thus making the roll well-suited for use e.g. as a spreader roll in conjunction with the handling of web-like material. A segmented roll is also suited for use e.g. as a guide roll for a paper web or as a pressure roll in web winding.

In known segmented rolls, each of the roll segments is generally pivoted at both its ends on bearings on a mounting frame or a similar support framework. Often, two adjacent roll segments share one bearing unit. Thus, each roll is pivoted on bearings so that it is allowed to rotate independently of the adjacent roll segment.

Publication FI 106277B1 discloses a segmented roll comprised of a plurality of end-to-end mounted roll segments, each adapted to rotate on bearings supported on a separate support shaft. According to the publication, both axial end surfaces of the support shafts of the roll segments in the segmented roll are provided with coupling means serving to disengageably connect two adjacent roll segments to each other. The support shaft comprises at least two parts, by changing the mutual disposition of which the axial length of the support shaft can be altered. Here, the bowing point between two adjacent roll segments is arranged to coincide with the mating surface of their ends, whereby the roll will bow evenly without any toothed jaggedness between the roll segments. Hence, the roll construction is advantageous in this respect.

In fiber-web machines, segmented rolls are generally used for web handling and for web travel control. Each roll segment of the segmented roll is independently pivoted on bearings and independently rotatable, and thereby the segmented roll is also a non-driven roll. In other words, it obtains the necessary rotational energy from the web passing on top of it. This is one of the reasons why the bearing assembly, or generally the supporting arrangement, of the roll segments allows the roll segments to rotate very lightly.

In case of a web break, the segmented roll remains rotating freely until it stops. For successful re-start of the process, the rotation of the segmented roll needs to be stopped. However, the stopping of a freely rotating roll takes a lot of time, even 10 minutes. Naturally, the time used for waiting for the roll to stop is excluded from the production of the fiber-web machine. A segmented roll is also hard to stop in the respect that its roll segments are not coupled with one another in such a way that they would transmit any braking force to each other mechanically.

An object of the invention is to provide a segmented roll assembly that enables the stopping of the rotary motion of a rotating segmented roll safely and efficiently.

Likewise, an object of the invention is to provide a braking device for a segmented roll that also enables the stopping of the rotary motion of a rotating segmented roll safely and efficiently.

To achieve this object, and the other objects hereinafter, the stopping device for a segmented roll in a fiber-web machine according to the invention for assisting the stopping of the rotation of one or more roll segment(s) of the segmented roll comprises at least one braking device, by means of which a roll segment can be stopped, and at least one surface contact member, which surface contact member is connected to said braking device. Further, the stopping device comprises actuators for optionally bringing/releasing the surface contact member into/from surface contact with the shell of one or more roll segment(s).

Preferably, the surface contact member comprises at least one shaft, onto which the contact surface member is rotatably supported, and the braking device is arranged in conjunction with said shaft so as to act directly on a part of the surface contact member.

Preferably, the braking device is a friction brake and the surface contact member is a wheel.

Since the braking device and the surface contact member are preferably manufactured so as to have low inertia, the braking device can be continuously in braking mode. This makes the device simple and thereby reliable in running.

If so required, the braking device may be optionally in braking mode or in released mode. In the stopping process, the freely rotating surface contact member can thus be accelerated faster to the surface speed of the roll segment and thereby, less slipping is bound to occur.

Preferably, the part of the surface contact member supported onto the shaft is provided with a friction surface for the braking device, on which surface the braking device is arranged to act.

Preferably, the braking device is air-cooled. According to an advantageous embodiment, this is embodied by arranging the compressed-air connection to the braking device for the surface contact member so that it opens into the braking device.

### SUMMARY OF THE INVENTION

To achieve the objects of the invention, the segmented roll assembly for a fiber-web machine according to the invention comprises a segmented roll, in which assembly the segmented roll comprises at least two, independently from one another rotatable roll segments that are located end-to-end substantially in the transverse direction of the fiber-web machine, and further, a stopping device for the segmented roll for assisting the stopping of the rotation of one or more roll segment(s) of the segmented roll, which stopping device comprises at least one braking device, by means of which the roll segment can be stopped, and at least one surface contact member, which surface contact member is connected to said braking device. Further, the stopping device comprises actuators for optionally bringing/releasing the surface contact member into/from surface contact with the shell of one or more roll segment(s).

According to one embodiment, the segmented roll assembly comprises one stopping device for each roll segment of the segmented roll.

According to another embodiment, each stopping device is arranged in conjunction with the segmented roll so that its surface contact member extends substantially in the transverse direction of the fiber-web machine over the mating surface between two roll segments.

According to one embodiment, the segmented roll assembly comprises one stopping head for each roll segment of the segmented roll.

According to another embodiment, each stopping head is arranged in conjunction with the segmented roll so that its surface contact member extends substantially in the transverse direction of the fiber-web machine over the mating surface between two roll segments.

Other, additional characteristic features of the invention are disclosed in the appended claims and in the following description of the embodiments shown in the figures.

As soon as the web in the fiber-web machine breaks, or the web travel ceases, the rotation of each individual roll segment can be stopped efficiently and safely.

### BRIEF DESCRIPTION OF THE DRAWINGS

FIG. 1 shows schematically one embodiment of the stopping device for a segmented roll according to the invention.

FIG. 2 shows schematically the partial section 11-11 of the stopping head of the stopping device of FIG. 1.

FIG. 3 shows an exemplary embodiment of the segmented roll assembly according to the invention.

FIG. 4 shows another embodiment of the segmented roll assembly according to the invention.

FIG. 5 shows another embodiment of the stopping device for a segmented roll.

### DESCRIPTION OF THE PREFERRED EMBODIMENTS

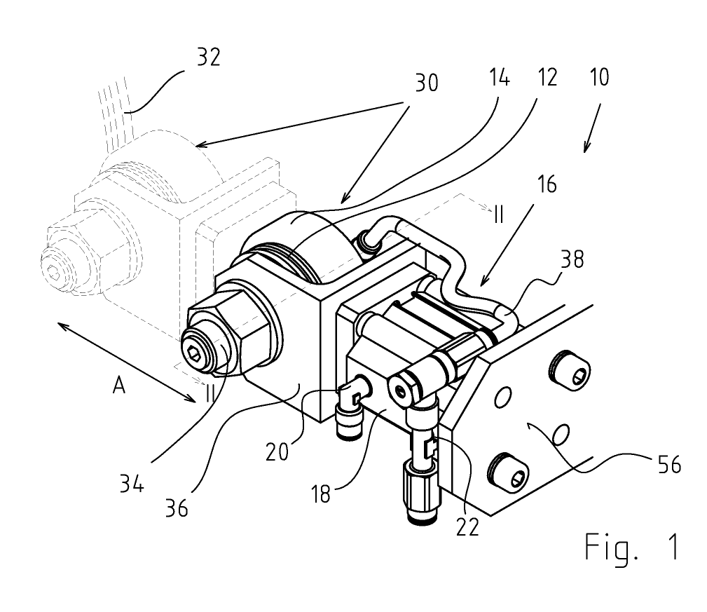

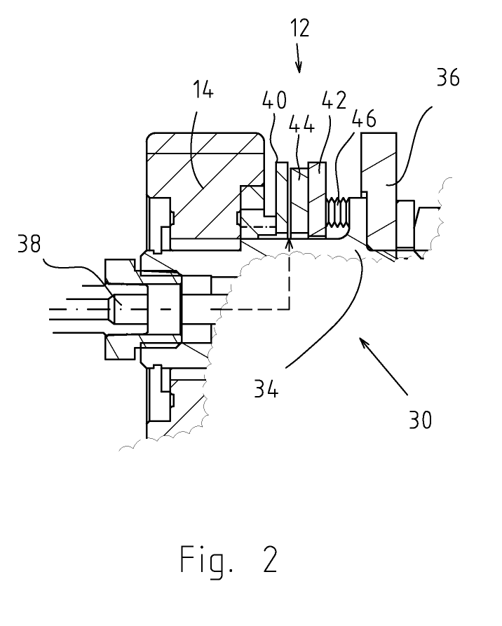

In the following, one embodiment of the stopping device 10 for a segmented roll in a fiber-web machine according to the invention will be described with special reference to FIGS. 1 and 2. The stopping device 10 is intended for assisting the stopping of the rotation of one or more roll segment(s) of the segmented roll in a fiber-web machine. A segmented roll refers to an assembly, in which at least two, independently from one another rotatable roll segments are arranged end-to-end.

The principal parts of the stopping device 10 are a braking device 12, by means of which the roll segment can be stopped, a surface contact member 14, which is connected to said braking device 12, and actuators 16 for optionally bringing/releasing the surface contact member into/from surface contact with the shell of one or more roll segment(s).

The actuators 16 of the stopping device for placing the surface contact member 14 against the roll surface, i.e. into surface contact, comprises in this embodiment a pneumatic cylinder 18, which is double-acting. Thus, it comprises a first compressed-air conduit 20 and a second compressed-air conduit 22. These are connected to respective sides of the cylinder piston, whereby the cylinder 18 can, by means of convenient air supply, be taken into a desired position. The braking device 12 and the surface contact member 14 of the stopping device are adapted at the end of the piston rod of the pneumatic cylinder 18. This assembly is called a stopping head 30. Preferably, the stopping device consists of the stopping head that is movable as a single unit, and of the actuators 16 for moving the stopping head. Preferably, the braking device is air-cooled. In this embodiment, the air-cooling is arranged so that from the compressed-air conduit 22, which in activated mode makes the surface contact member 12 move into contact with a roll segment, there is also a compressed-air connection 38 to the braking device 12 of the surface contact member. The compressed-air connection 38 is arranged so as to deliver cooling air to the braking device whenever the surface contact member is brought onto the surface of the roll segment. In practice, the actuators may also be embodied differently, for instance as a lever mechanism that turns or moves the stopping head. The stopping device 10 can be attached to a suitable structural element, e.g. to a supporting beam 56, via the actuator 16.

The surface contact member 14 is preferably a wheel and accordingly, in FIGS. 1-4 the surface contact member 14 is a wheel. Thus, the surface contact member 14 comprises a shaft 34, which is supported onto the body 36 of the stopping head. The body 36 is connected to the end of the piston rod of the pneumatic cylinder 18 that acts as an actuator 16.

In FIG. 1, the surface 32 of the segmented roll is shown schematically as a ruled area and the stopping head 30 that is brought into contact with the surface is shown by a dashed line. The movement is illustrated by an arrow A. As soon as the web travel over the segmented roll has ceased for any reason and the aim is to stop the rotation of the roll segments of the segmented roll, the stopping head 30 is moved into connection with the surface of the roll segment and after this at the latest, the braking device is switched on.

In the embodiment shown herein, the surface contact member 14 is arranged, by means of a bearing, so that it rotates freely on the shaft 34, whereby the shaft is arranged onto the body 36 so as not to rotate. The braking device 12 is also arranged in conjunction with the shaft so as to act directly on the surface contact member 14 or a part thereof. Preferably, the braking device is a friction brake. With special reference to FIG. 2, the braking device comprises in this embodiment a first discoid member 40, which is arranged in conjunction with the contact surface member, and a second discoid member 42, which is arranged on the shaft 34 so that its movement in the longitudinal direction of the shaft is allowed, but its rotation on the shaft is prevented. The braking device comprises further a friction surface 44 on the second discoid member so that the friction surface is located between the first and second discoid member. A brake actuator 46 (FIG. 2) is arranged in conjunction with the second discoid member 42, which brake actuator exerts force on the second discoid member in the longitudinal direction of the shaft 34 to make the second discoid member press the friction surface 44 against the first discoid surface. This provides a braking effect. The brake actuator 46 can be controllable in such a way that the braking is not initiated until the actuators 16 have moved the surface contact member 14 of the stopping head 30 into connection with the surface of the roll segment. Then, the surface contact members are accelerated first to the same surface speed with the roll segment and only thereafter the braking device is activated. The braking device is thus optionally in braking mode or in released mode.

According to one embodiment, the brake actuator 46 (FIG. 2) is a spring. Then, the braking device is continuously in braking mode. When the spring force to be used and the frictional force between the surface contact member and the roll segment are selected suitably, the surface contact member can be made to accelerate to the same surface speed with the roll segment sufficiently fast, even if the braking device were constantly in activated mode.

FIG. 2 shows also an advantageous embodiment of the invention, according to which the compressed-air connection 38 to the braking device 12 for the surface contact member is arranged so as to open into the braking device, whereby a cooling air flow passes on the surfaces of the braking device elements, while it is released to the environment.

In the surface contact member, at least the outer surface is selected suitably so that the transmission of the braking force from the surface of the roll segment to the braking device occurs without any substantial slipping.

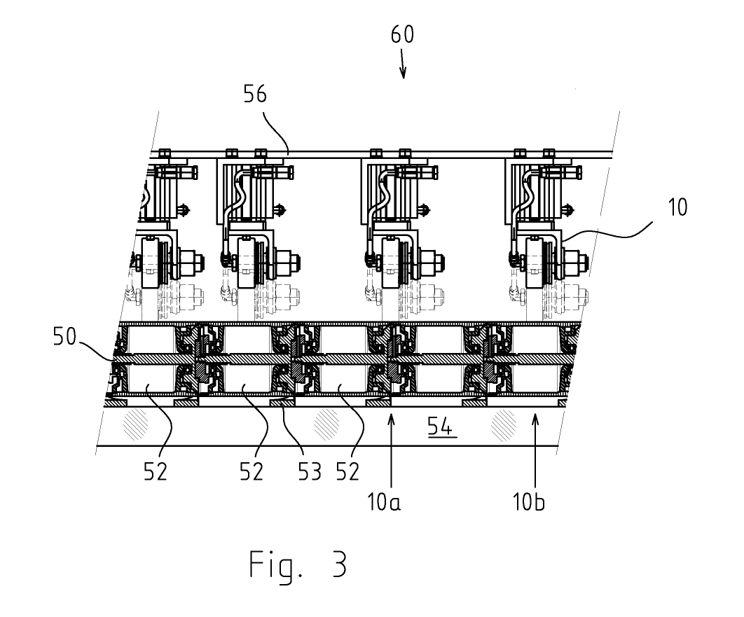

FIG. 3 shows schematically a segmented roll assembly 60. The segmented roll 50 included therein comprises end-to-end mounted roll segments 52. In the embodiment according to FIG. 3, one end of the roll segment 52 is supported onto a mounting frame 54 via a support element 53 and the other end onto the end surface of an adjacent roll segment. The mounting frame is, for instance, a beam or the like that traverses the fiber-web machine. Each individual roll segment 52 is adapted to rotate on bearings supported by a stationary support shaft of its own. The joint between two end-to-end mounted roll segments 52 is arranged so that it allows limited inclination of the adjacently placed roll segments 52 with respect to one another. The fastening of the roll segments 52 to the mounting frame 54 is arranged so that it allows adjustment of the position of an individual roll segment 52 both in the vertical and lateral direction of the roll, whereby the bow of the segmented roll can be easily adjusted.

The segmented roll assembly 60 comprises, depending for instance on the construction of the segmented roll, one or several stopping device(s) 10 for the segmented roll. FIG. 3 shows two different embodiments of the adaptation of the stopping device in the assembly. The reference number 10a refers to the position of the stopping device 10, in which its surface contact member 14 extends substantially in the transverse direction of the fiber-web machine (i.e. in the longitudinal direction of the segmented roll) over the mating surface between two roll segments. The reference number 10a in the figure refers to a situation, in which the surface contact member is adapted in the middle of the mating surface between the roll segments, but the traversing may also occur in another way. The reference number 10b refers to the position of the stopping device 10, in which its surface contact member 14 extends substantially in the transverse direction of the fiber-web machine (i.e. in the longitudinal direction of the segmented roll) to the shell area of the roll segment, i.e., in FIG. 3 by way of example, right to the middle of the shell.

In FIG. 3, the resting position of the surface contact member is shown by a continuous line, and the position, in which it is in contact with the surface of the roll segment is shown by a dashed line.

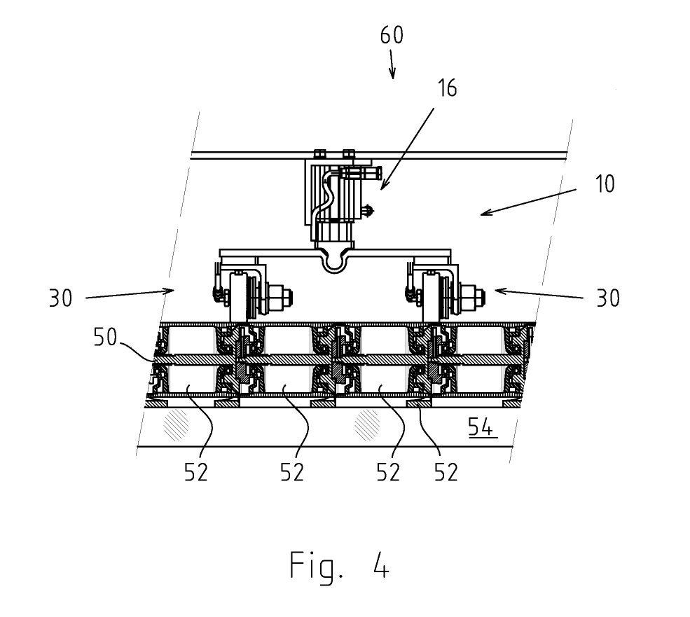

FIG. 4 shows another embodiment of the segmented roll assembly 60 according to the invention. Here, the stopping device comprises one actuator 16 for two stopping heads 30.

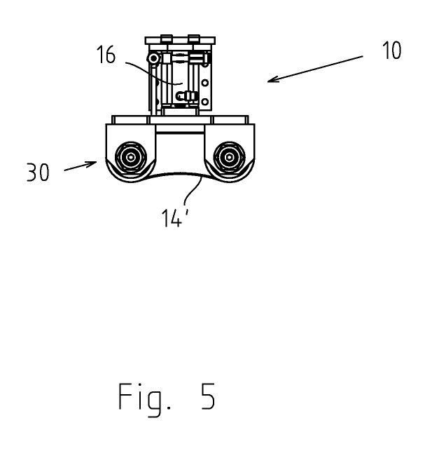

FIG. 5 shows another embodiment of the stopping device 10 for a segmented roll. Here, the stopping device comprises a stopping head 30, which is provided with a belt-like surface contact member 14′ arranged around two wheels or the like. Within the scope of the invention it is conceivable that the stopping head 30 is, if so required, provided with a booster motor, by which the surface contact member can be accelerated so as to correspond to the surface speed of the roll segment before they are brought into contact with one another. Then, the booster motor is preferably pneumatic.

The stopping device for a segmented roll according to the invention is advantageous also when modernizing an existing fiber-web machine. Then, a stopping device according to the invention is arranged in the vicinity of the segmented roll in the existing fiber-web machine at such a distance from the surface of the segmented roll that the actuators for optionally bringing/releasing the surface contact member into/from surface contact provide such a movement of the stopping head that is at least as long as said distance.

It is to be noted that only a few most advantageous embodiments of the invention are described in the above. Thus, it is clear that the invention is not limited to the above-described embodiments, but may be applied in many ways within the frame of the appended claims. The features described in conjunction with the different embodiments may be used in conjunction with other embodiments as well and/or various combinations of the described features may be made within the frame of the basic idea of the invention, if so desired, and if technical feasibility for this exists.

1-12. (canceled)

13. A stopping device for a segmented roll in a fiber-web machine for braking rotation of at least one roll segment of the segmented roll, comprising:
at least one braking device operable to stop a roll segment;
at least one surface contact member, which surface contact member is connected to said braking device; and
at least one actuator for bringing the surface contact member into and out of surface contact with the at least one roll segment.

14. The stopping device of claim 13 further comprising at least one shaft onto which the surface contact member is rotatably supported, and wherein the braking device is arranged in conjunction with said shaft so as to act directly on a part of the surface contact member.

15. The stopping device of claim 13 wherein the braking device is a friction brake.

16. The stopping device of claim 13 wherein the surface contact member is a wheel.

17. The stopping device of claim 13 wherein the braking device is arranged continuously in a braking mode.

18. The stopping device of claim 13 wherein the braking device is switchable between a braking mode and a released mode.

19. The stopping device of claim 14 wherein the part of the surface contact member supported onto the shaft is provided with a friction surface on which surface the braking device is arranged to act.

20. The stopping device of claim 15 wherein the braking device is air-cooled.

21. The stopping device of claim 20 wherein a compressed-air connection to the braking device is arranged so as to open into the braking device.

22. A segmented roll assembly for a fiber-web machine, comprising:
a segmented roll having a plurality of independently from one another rotatable roll segments that are located end-to-end substantially in a transverse direction defined by the fiber-web machine, the plurality of roll segments having mating surfaces between said end to end roll segments;
at least one stopping device for braking rotation of at least one roll segment of the segmented roll, said stopping device further comprising:
at least one stopping head, having at least one braking device operable to stop a roll segment, and a surface contact member, which surface contact member is connected to said braking device; and
at least one actuator for bringing the surface contact member into and out of surface contact with a shell of the at least one roll segment.

23. The stopping device of claim 13 further comprising at least one shaft onto which the surface contact member is rotatably supported, and wherein the braking device is arranged in conjunction with said shaft so as to act directly on a part of the surface contact member to form a friction brake.

24. The assembly of claim 23 further comprising a source of compressed air in cooling air supplying relation to the friction brake.

25. The assembly of claim 22 wherein the surface contact member is a wheel.

26. The assembly of claim 25 wherein the wheel has mounted thereto a surface that rotates with the wheel, and wherein the braking device include a braking member mounted for movement and biased by a spring toward the surface that rotates with the wheel, wherein the movable braking member is mounted to prevent rotation of the stopping device so as to produce a braking frictional force between said movable braking member and the surface that rotates with the wheel.

27. The assembly of claim 22 wherein the braking device is switchable between a braking mode and a release mode.

28. The assembly of claim 23 wherein the part of the surface contact member supported onto the shaft is provided with a friction surface on which surface the braking device is arranged to act.

29. The assembly of claim 22 wherein the segmented roll assembly comprises one stopping head for each roll segment of the segmented roll.

30. The assembly of claim 22 wherein each stopping head is arranged in conjunction with the segmented roll so that its surface contact member extends substantially in the transverse direction of the fiber-web machine over the mating surface between two roll segments.

31. A segmented roll assembly for a fiber-web machine, comprising:
a segmented roll having a plurality of rotatable roll segments, each roll segment having a shell and a shell surface, the roll segments arranged end-to-end along the segmented roll, the plurality of roll segments having mating surfaces between the end to end roll segments;
at least one stopping device for braking rotation of at least one roll segment of the segmented roll, said stopping device further comprising:
a stopping head having a body, a wheel mounted for rotation on a shaft to the body, the wheel having an outer contact surface substantially parallel to the shell surface, and a braking device in braking relation between the body and the wheel;
wherein the body is mounted to a support beam on the fiber-web machine by an actuator which is arranged to move the body and the wheel mounted thereto toward the segmented roll to bring the outer contact surface into engagement with the shell surface.

32. The segmented roll assembly of claim 31 wherein the wheel has mounted thereto a surface that rotates with the wheel, and wherein the braking device is formed by a movable braking member having a surface opposed to the surface that rotates with the wheel, the movable braking member mounted to the body for movement toward the surface that rotates with the wheel, wherein a biasing member biases the movable braking member into engagement with the surface that rotates with the wheel, so as to produce a braking frictional force between said movable braking member surface and the surface that rotates with the wheel.
